(19) United States
(12) Patent Application Publication
(10) Pub. No.: US 2025/0176596 A1
(43) Pub. Date: Jun. 5, 2025

(54) HEAT-TREATED MOCHI-CONTAINING FOOD AND METHOD OF PRODUCING THE SAME, AND LIQUID SEASONING FOR HEAT-TREATING MOCHI AND USE THEREOF

(71) Applicants: SHINGEN FOODS CO., LTD., Koushu-shi, Yamanashi (JP); TABLE STOCK CO., LTD., Koushu-shi, Yamanashi (JP)

(72) Inventor: Satoshi SHIRASAWA, Koushu-shi (JP)

(73) Assignees: SHINGEN FOODS CO., LTD., Koushu-shi, Yamanashi (JP); TABLE STOCK CO., LTD., Koushu-shi, Yamanashi (JP)

(21) Appl. No.: 18/842,476

(22) PCT Filed: Feb. 24, 2023
(86) PCT No.: PCT/JP2023/006690

§ 371 Date: Aug. 29, 2024

(30) Foreign Application Priority Data
Mar. 8, 2022 (JP) 2022-035256

(51) Int. Cl. A23L 7/10; A23B 9/02; A23L 29/30

(52) U.S. Cl. CPC A23L 7/10; A23B 9/02; A23L 29/35

(57) ABSTRACT

A heat-treated mochi-containing food that maintains the texture and appearance of mochi without impairing its original taste, a method for producing the same, as well as a liquid seasoning for heat-treating mochi and use of the same. The above objective is solved by the heat-treated mochi-containing food including a liquid seasoning and mochi, wherein the liquid seasoning includes dextrin at a ratio between 1.0% by mass or more and less than 20.0% by mass and has a Brix value of 26.0% to 52.5%.

### TECHNICAL FIELD

The present invention relates to a heat-treated mochi-containing food, wherein the heat-treated food maintains the texture of mochi, and a method of producing the same, as well as a liquid seasoning for heat-treating mochi and use thereof.

### BACKGROUND ART

Rice cakes called Mochi in Japanese is used in dishes such as zoni, shiruko, zenzai, etc. Mochi in such dishes is cooked just before consumption in general, because mochi will become hardened over time (retrogradation) after cooking, while mochi will lose its viscoelasticity and result in collapse in the shape (lose the shape, e.g., becoming melted or mushy), during prolonged cooking. Thus, such dishes with mochi are difficult to maintain the unique texture of mochi, limiting their wide use in the general ready-made foods and confectionery fields.

In particular, mochi used in retort products (ready-to-eat meal) and other similar products intended for long-term storage may reduce its viscoelasticity and easily collapse in the shape (lose the shape) by heat sterilization at high temperatures, resulting in a loss of its texture and appearance.

In recent years, methods of maintaining the texture and appearance of mochi are known, including for example, adding additives that are not derived from rice to mochi. (See, for example, Patent Documents 1 to 6.)

In addition, Patent Document 7 describes a method of obtaining a food containing mochi that maintains its texture by heat-sterilizing mochi in a liquid seasoning containing 20% by weight to 35% by weight of dextrin with a DE of 4 to 11.

### CITATION LIST

### Patent Documents

[Patent Document 1] Japanese Unexamined Patent Publication No. 60-241863
[Patent Document 2] Japanese Unexamined Patent Publication No. 09-28299
[Patent Document 3] Japanese Unexamined Patent Publication No. 09-238630
[Patent Document 4] Japanese Unexamined Patent Publication No. 10-23869
[Patent Document 5] Japanese Unexamined Patent Publication No. 2009-124950
[Patent Document 6] Japanese Unexamined Patent Publication No. 2014-3972
[Patent Document 7] Japanese Patent No. 6973806

### SUMMARY OF THE INVENTION

### Problems to be Solved by the Invention

However, the methods by adding additives described in Patent Documents 1 to 6 have a problem that the original taste of mochi is impaired.

The present inventor found that although the method described in Patent Document 7 can produce a food product containing mochi maintaining its texture, it may excessively accelerate the hardening (retrogradation) of mochi when consumed. The present inventor also found that the method described in Patent Document 7 may render the viscosity specific to starch and the sweetness specific to dextrin excessive, and may impair the flavor and value of food products such as zoni, etc., thus limiting the types of food products.

Therefore, an objective of the present invention is to provide a heat-treated mochi-containing food and its producing method, and a liquid seasoning for heat-treating mochi and its use, in which the texture and appearance of mochi is maintained without impairing the original taste of mochi.

### Means of Solving the Problems

To solve the above problems, the present inventor has conducted diligent research on liquid seasoning that would maintain the texture and appearance of mochi, on the basis of improving liquid seasoning to be added when cooking mochi instead of improving the physical characteristics of mochi itself so as not to impair the original flavor of mochi. The present inventor then realized that the method described in the Patent Document 7 when the amount of dextrin in the liquid seasoning is excessively higher than the amount of soluble solid ingredients which are Brix value adjusting components other than dextrin, can maintain the shape of mochi during heat sterilization treatment, but may excessively accelerate hardening (retrogradation) of mochi when consuming. The inventor has considered the following causes for this phenomenon. That is, when the amount of dextrin in the liquid seasoning is appropriate, the water transfer will occur between the liquid seasoning and mochi to reach an even water content within its container, and the shape of mochi can be retained during heat sterilization treatment. However, when the amount of dextrin in the liquid seasoning is excessively larger than the amount of soluble solid ingredients, the viscosity of the liquid seasoning becomes higher and a film on the surface of mochi is formed due to the large molecule (molecular weight) of dextrin, causing poor water transfer between the liquid seasoning and mochi during heat sterilization treatment. As the hardening (retrogradation) of mochi is progressed during storage after heat sterilization treatment, the moisture of mochi itself will be expelled due to retrogradation, and this moisture will transfer only toward the liquid seasoning, resulting in poor water content in the whole mochi. Therefore, when it is heated again for gelatinization, the shortage of moisture leads to provide insufficiently gelatinized areas and thus insufficient viscoelasticity. In addition, it is thought that the retrogradation rate is accelerated in insufficiently gelatinized areas, consequently a hard and un-stretchable texture is rendered in a short period of time during consumption.

Therefore, the inventor repeatedly trial and error to find a liquid seasoning that could maintain the texture and appearance of mochi while reducing the amount of dextrin in the liquid seasoning so that the hardening (retrogradation) of mochi would not be accelerated excessively when consumption. Finally, by adjusting the balance between the dextrin amount and Brix value in the liquid seasoning, the present inventor succeeded in suppressing decrease of viscoelasticity of mochi and suppressing collapse of the shape of mochi (becoming melted or mushy) while maintaining the texture and appearance of mochi without impairing its original taste. Surprisingly, it was also found that even when subjected to high-temperature heat sterilization treatment such as retort sterilization, the above-mentioned liquid seasoning could suppress decrease in viscoelasticity of mochi and suppress collapse of the shape of mochi while maintaining the texture and appearance of mochi, without impairing the original taste of mochi, and could also maintain the texture and appearance of mochi even when stored for a long period of time. Furthermore, since the dextrin amount in the liquid seasoning was not excessive, it could avoid making viscosity and sweetness of the liquid seasoning excessive, and achieve desirable flavor of the overall product. The present invention has been completed on the basis of such successful examples and findings.

Therefore, according to the present invention, the following aspects are provided:
[1] A heat-treated mochi-containing food comprising a liquid seasoning and mochi, wherein the liquid seasoning comprises dextrin at a ratio between 1.0% by mass or more and less than 20.0% by mass and has a Brix value of 26.0% to 52.5%.
[2] The heat-treated mochi-containing food according to [1], wherein the heat-treated mochi-containing food has a Brix value of 36.5% to 54.0%.
[3] The heat-treated mochi-containing food according to any one of [1] to [2], wherein the liquid seasoning is comprised at a ratio of 50 parts by mass to 300 parts by mass relative to 100 parts by mass of the mochi.
[4] The heat-treated mochi-containing food according to any one of [1] to [3], wherein the heat-treated mochi-containing food is packed in a retort container.
[5] A method of producing a heat-treated mochi-containing food, comprising subjecting mochi to heat treatment in a liquid seasoning that comprises dextrin at a ratio between 1.0% by mass or more and less than 20.0% by mass and having a Brix value of 26.0% to 52.5%, to obtain the heat-treated mochi-containing food.
[6] The method according to [5], wherein the heat-treated mochi-containing food has a Brix value of 36.5% to 54.0%.
[7] The method according to any one of [5] to [6], wherein the liquid seasoning is comprised at a ratio of 50 parts by mass to 300 parts by mass relative to 100 parts by mass of the mochi.
[8] The method according to any one of [5] to [7], wherein the heat treatment is a retort sterilization treatment.
[9] A liquid seasoning for heat-treating mochi, comprising dextrin at a ratio between 1.0% by mass or more and less than 20.0% by mass and having a Brix value of 26.0% to 52.5%.
[10] A method for preventing collapse of the shape of mochi during heating, comprising subjecting mochi to heat treatment in a liquid seasoning that comprises dextrin at a ratio between 1.0% by mass or more and less than 20.0% by mass and has a Brix value of 26.0% to 52.5%.

### Effect of the Invention

According to the present invention, by using a liquid seasoning containing a specific amount of dextrin and having a Brix value in a specific range for heat treatment of mochi, the decrease in viscoelasticity of mochi is suppressed and the texture and appearance of mochi are maintained without impairing the original taste of mochi.

According to the present invention, even when subjected to high-temperature heat sterilization treatment such as retort sterilization, the decrease in viscoelasticity of mochi is suppressed, preventing collapse of the shape of mochi (losing the shape), and the texture and appearance of mochi is maintained even after long-term storage.

### DESCRIPTION OF EMBODIMENTS

While a heat-treated mochi-containing food and a method of producing the same, and a liquid seasoning for heat-treating mochi and its use according to one aspect of the present invention will now be described in further details, the scope of the present invention is not limited to what is described in this section; rather, the present invention may take various other forms to the extent that its objective is achieved.

Unless otherwise specified, each term used herein is used in the meaning commonly used by those skilled in the art and should not be construed to have any meaning that is unduly limiting.

The term “amount (content)” as used herein is equivalent to “concentration” and means the proportion (for example, % by mass) of the amount (for example, mass) of component relative to the total amount (for example, volume).

The terms “include, “comprise,” and “contain” mean that an element(s) other than an element(s) as explicitly indicated can be added as inclusions, which are, for example, synonymous with “at least include,” but encompasses the meaning of “consist of” and “substantially consist of”. In other words, the terms may mean, for example, to include an element(s) as explicitly indicated as well as any one element or any two or more elements, to consist of an element(s) as explicitly indicated, or substantially consist of an element(s) as explicitly indicated. Such elements include limitations such as components, steps, conditions, and parameters.

The wording “to” for indicating a range of values is intended to include values preceding and following the wording; for example, “0% to 100%” means the range from 0% or more and 100% or less. The wording “more than” and “less than” mean the lower limit and the upper limit, respectively, without including the following numerical value. For example, “more than 1” means a value beyond 1, and “less than 100” means a value below 100.

The number of digits of an integer equals to its significant figure. For example, 1 has one significant figure and 10 has two significant figures. For a decimal number, the number of digits after a decimal point equal to its significant figure. For example, 0.1 has one significant figure and 0.10 has two significant figures.

### [Heat-Treated Mochi-Containing Food]

The heat-treated mochi-containing food according to one embodiment of the present invention comprises a liquid seasoning and mochi which are subjected to heat treatment, wherein the liquid seasoning comprises dextrin at a ratio between 1.0% by mass or more and less than 20.0% by mass and has a Brix value of 26.0% to 52.5%.

The heat-treated mochi-containing food according to one embodiment of the present invention comprises a liquid seasoning and mochi which are subjected to heat treatment, wherein the method of heat treatment is not particularly limited, and can adopt any heat treatment method usually used in food production.

### [Liquid Seasoning]

The liquid seasoning according to one embodiment of the present invention contains dextrin at a ratio between 1.0% by mass or more and less than 20.0% by mass, and has a Brix value of 26.0% to 52.5%, for heat-treating mochi. By using such liquid seasoning for heat-treating mochi, it is possible to suppress decrease in viscoelasticity of mochi and to suppress collapse of the shape of mochi (during heating or cooking), and to maintain the texture and appearance of mochi and to prevent excessive hardening (retrogradation) of mochi at the time of consumption without impairing the original taste of mochi. In addition, even when subjected to high-temperature heat sterilization, such as retort sterilization, it is possible to suppress decrease in viscoelasticity and collapse of the shape of mochi and maintain the texture and appearance of mochi without impairing the original taste.

### [Dextrin]

The dextrin contained in the liquid seasoning according to one embodiment of the present invention is contained at a ratio between 1.0% by mass or more and less than 20.0% by mass of the liquid seasoning, preferably at a ratio between 5.0% by mass to 15.0% by mass.

Because the amount of dextrin in the liquid seasoning according to one embodiment of the present invention is not excessively large, i.e., it is less than 20% by mass, it can avoid that the viscosity and sweetness of the liquid seasoning become excessive degree, therefore the overall flavor of the product can be desirable.

Dextrin can be used without particular limitation as long as it can be used in general for foods.

Examples of dextrin includes dextrin having a DE value of about 4 to 10 and maltodextrin having a DE value of about 10 to 18. Dextrin can be used alone or in combination of two or more.

The Brix value of dextrin is about 9.5% when 10 g of dextrin is dissolved in 100 g of water.

### [Soluble Solid Ingredients]

In the liquid seasoning according to one embodiment of the present invention, soluble solid ingredient(s), which is Brix value adjusting component(s), is contained in addition to dextrin in order to achieve a Brix value of 26.0% to 52.5%. Such soluble solid ingredients can be used without limitation as long as they can be used in foods in general, and one type alone or a combination of two or more types can be used.

Specifically, the soluble solid ingredients include sugars such as glucose, maltose, sucrose, starch syrup, hydrogenated sugar alcohols; amino acids such as glutamic acid and aspartic acid; inorganic salts such as salt; organic acids such as citric acid and malic acid; polysaccharides such as pectin; and other components with light refractive properties. Among these, sucrose (sugar), sugar alcohols, and salt are preferred due to their high permeability.

For example, the Brix value of sucrose (sugar) is about 10% when 10 g of sucrose (sugar) is dissolved in 90 g of water, the Brix value of salt is about 9.5% when 10 g of salt is dissolved in 90 g of water, and the Brix value of sugar alcohol is about 7.5% to 10% when 10 g of sugar alcohol is dissolved in 90 g of water.

The content of soluble solid ingredients is not particularly limited as long as the Brix value of the liquid seasoning can be adjusted to the range of 26.0% to 52.5%, but is preferably 30.0% by mass to 45.0% by mass of the liquid seasoning, more preferably 30.0% by mass to 40.0% by mass.

### [Brix Value]

The Brix value of the liquid seasoning according to one embodiment of the present invention is in the range of 26.0% to 52.5%, preferably 30.0% to 40.0%.

If the Brix value of the liquid seasoning is excessively large, the liquid seasoning may have excessive viscosity and sweetness and accelerate hardening (retrogradation) of mochi when consumed. On the other hand, if the Brix value of the liquid seasoning is deficiency, the decrease in viscoelasticity of mochi cannot be suppressed even by heat-treating mochi in the liquid seasoning, and thus the mochi may melt into the liquid seasoning.

In the present invention, the Brix value refers to an indication of a refractometer for sugar at a sample temperature of 20° C.

In the present invention, the Brix value of the liquid seasoning is the value measured by the method described in the example below.

The Brix value can be adjusted mainly by adjusting the dextrin content and/or the type or content of soluble solid ingredients in the liquid seasoning.

### [Other Ingredients]

The liquid seasoning according to one embodiment of the present invention may contain other ingredients in addition to dextrin and soluble solid ingredients. The aforementioned other ingredients are not particularly limited, but are, for example, water, seasonings, yeast extract, meat extract (chicken extract, pork extract, beef extract, fish meat extract, etc.), fruit juice (apple juice, etc.), vegetable juice (tomato puree, etc.), spices (ginger, capsicum, pepper, basil, oregano, etc.), coloring agents, amino acid-based seasonings, nucleic acid-based seasonings, organic acid-based seasonings, flavor enhancing additives, flavors, dairy products, thickening agents (starch, processed starch, xanthan gum and other gums) and the like, and they can be used either individually or in combination of two or more.

While the method for preparing the liquid seasoning is not particularly limited, it can be prepared by weighing, mixing or blending, and, as necessary, heating dextrin, soluble solid ingredients, as well as other ingredients, if desired.

### [Mochi (Rice Cake)]

Mochi used in the heat-treated mochi-containing food according to one embodiment of the present invention may be not particularly limited as long as it is manufactured using rice (glutinous rice, non-glutinous rice, or their powders (e.g., non-glutinous rice flour (joshin flour), glutinous rice flour (shiratama flour), etc.)) as a raw material. Specifically, mochi for use can be produced by using rice as a raw material, and heat-treating the rice with steam together with water, pounding the steamed rice and then forming into a shape. The mochi may include, for example, a pounded mochi or a kneaded mochi (dumpling such as shiratama or tteok). It may also be manufactured with additives or other ingredients in the raw material to the extent that they do not detract from the original flavor of mochi.

In the mochi-containing food before heat treatment in the present invention, mochi preferably has not pregelatinized (so-called alpha-formation), or has a low degree of alpha-formation.

### [Food Materials]

In the heat-treated mochi-containing food of one embodiment of the present invention, other food ingredients (food materials) may be contained in the mochi-containing food (before heat treatment) together with the liquid seasoning and mochi. The aforementioned other food materials include, but are not limited to, for example, meat, seafood, vegetables, fruits, soybean products and the like. These other food materials may be subjected to cooking process with the liquid seasoning. The content of other food materials is appropriately determined depending on the type of product or the like, and is not particularly limited, it is, for example, 5% by mass to 30% by mass of the total content of the liquid seasoning and mochi.

In the heat-treated mochi-containing food of one embodiment of the present invention, the content ratio of the liquid seasoning to mochi in the mochi-containing food (before heat treatment) can be appropriately determined depending on the type of mochi and the type of product, but for example, the liquid seasoning is preferably contained at a ratio of 50 parts by mass to 300 parts by mass relative to 100 parts by mass of the mochi, more preferably contained in a ratio of 80 parts by mass to 250 parts by mass, and even more preferably in a ratio of 100 parts by mass to 200 parts by mass.

Specifically, the heat-treated mochi-containing food of one embodiment of the present invention is about 50 g to 100 g of mochi, 30 g to 200 g of liquid seasoning, 15 g to 45 g of other food materials, and 95 g to 345 g in total per serving (per person).

In the heat-treated mochi-containing food of one embodiment of the present invention, the Brix value of the heat-treated mochi-containing food is preferably in the range of 36.5% to 54.0%, more preferably 40.0% to 50.0%.

In the present invention, the Brix value of the heat-treated mochi-containing food is measured by the method described in the example below.

Considering shelf life, the heat-treated mochi-containing food of one embodiment of the present invention may be a container-packed, heat-treated mochi-containing food subjected to heat sterilization or other anti-spoilage treatment. The heat sterilization treatment includes, for example, retort sterilization or pH-adjusted pasteurization.

According to the heat-treated mochi-containing food of one embodiment of the present invention, the texture and appearance of mochi is maintained for a long period of time, even when the food is packed in a container and heat sterilized.

The container used for container-packing is not particularly limited as long as it is made of a material and made from a shape that can withstand the heat sterilization treatment and can be sealed. Examples of them include packaging containers such as pouches, sachets, bottles, trays, cans, and bottles made of, for example, metal such as aluminum, plastic such as PET and PTP, one-layer or stacked-layer (laminated) film, glass, and the like. In particular, when a retort container is used, examples of the containers include, specifically, a container manufactured using stacked-layer (laminated) film provided with a heat-weldable resin layer made of an olefin resin such as polypropylene or polyethylene on its inside, and with a layer made of, for example, a resin having a high gas barrier property such as polyester or polyamide and/or aluminum foil on its outside. Retort containers for microwave heating include containers with steam vents.

### [Producing Method]

A method of producing a heat-treated mochi-containing food of one embodiment of the present invention comprises: subjecting mochi to heat treatment in a liquid seasoning that contains dextrin at a ratio between 1.0% by mass or more and less than 20.0% by mass and has a Brix value of 26.0% to 52.5%, to obtain the heat-treated mochi-containing food.

In the method of producing a heat-treated mochi-containing food of one embodiment of the present invention, the method of heat treatment mochi in the liquid seasoning is not particularly limited and can employ any heat treatment method normally used in food manufacturing. Examples of the method include: a method including placing and heating the liquid seasoning and mochi in a pot; a method including placing the liquid seasoning and mochi into a microwave-safe container and heating them in a microwave oven, and other method. Methods for container-packing may include heat sterilization such as retort sterilization. Among these, the heat treatment method is preferably an anti-spoilage treatment such as retort sterilization or other heat sterilization treatment, if shelf life is a consideration.

The method of producing the heat-treated mochi-containing food of one embodiment of the present invention, for example, when producing as a container-packed food, includes specifically: preparing a liquid seasoning containing dextrin at a ratio between 1.0% by mass or more and less than 20.0% by mass and having a Brix value of 26.0% to 52.5%; filling the liquid seasoning and mochi into a container together with other food materials as required, and sealing the opening of the container and heat-sterilizing to produce the container-packed, heat-treated mochi-containing food.

The temperature and time for the heat treatment can be appropriately determined according to the type of product, the blending amount, the filling amount, the type of container, and the like. For example, when the heat treatment is a retort sterilization treatment, it is carried out under pressure at 100° C. to 130° C., preferably about 125° C. for 6 minutes to 15 minutes, preferably 6 minutes to 9 minutes, having a F value, an index of the sterilization strength, of 4 or more, preferably 5 to 10. Known devices and methods for retort sterilization can be used. For example, in the case of heat sterilization treatment for canning and bottling, the heat sterilization treatment can be performed at 121° C. to 135° C. for 5 minutes to 30 minutes. Furthermore, for example, in the case of pH-adjusted pasteurization treatment, the pH of the liquid seasoning can be adjusted to the range of 3.8 to 4.5, and the treatment can be performed at 70° C. to 100° C. for 10 to 60 minutes. The method for adjusting pH includes, for example, adding a pH adjusting agent such as acetic acid, citric acid, phytic acid, or gluconic acid.

Such container-packed, heat-treated mochi-containing food subjected to heat sterilization treatment above can be stored for a long period of time at room temperature (15° C. to 25° C.). Such container-packed, heat-treated mochi-containing food can be heated when consumption, for example, boiling in boiling water for 3 to 10 minutes or heating in a microwave oven. Such container-packed, heat-treated mochi-containing food can maintain the texture and appearance of mochi even after long-term storage.

### [Prevention of Shape Collapse of Mochi]

The method for preventing collapse of the shape of mochi during heating (cooking) comprising subjecting mochi to heat treatment in a liquid seasoning that contains dextrin at a ratio between 1.0% by mass or more and less than 20.0% by mass and has a Brix value of 26.0% to 52.5%.

In the method for preventing collapse of the shape of mochi during heating of one embodiment of the present invention, method of heat treatment mochi in the liquid seasoning is not particularly limited, and any heat treatment commonly used in food production can be used.

As described above, according to the present invention, by heat-treating mochi in a liquid seasoning containing a specific content of dextrin and having a Brix value in a specific range, the heat-treated mochi-containing food can be obtained in which the decrease in viscoelasticity of mochi is suppressed and the texture and appearance of mochi are maintained without impairing the original taste of mochi and excessive hardening (retrogradation) of mochi is suppressed when the food is consumed. According to the present invention, even when subjected to high-temperature heat sterilization treatment such as retort sterilization, the heat-treated mochi-containing food can be obtained in which the decrease in viscoelasticity of mochi is suppressed, the collapse of the shape of mochi (losing its shape) is prevented, as well as the texture and appearance of mochi is maintained even after long-term storage. The reason why this effect is obtained might not be obvious, but it is assumed to be based on the following principle. It should be noted that such principle as below does not limit the technical scope of the present invention. That is, since dextrin in the liquid seasoning is large molecule (molecular weight), it is thought to slowly permeate mochi during the heat treatment. On the other hand, soluble solid ingredients (e.g., sugar and salt), which are the Brix value adjustment ingredients in the liquid seasoning, are small molecule (molecular weight), and therefore they are thought to penetrate faster mochi during the heating treatment. This balance between the different rates of penetration of dextrin and soluble solid ingredients into mochi is thought to maintain an appropriate level of moisture of mochi and, as a result, possible to maintain the viscoelasticity of mochi. In addition, the Brix value of the liquid seasoning is within an appropriate range so that the free water of the liquid seasoning does not decrease significantly when eating, and the overall moisture transfer can occur to no small extent, which is thought to possible to suppress the prevention of pregelatinization (α-formation) of mochi when eating.

Hereinafter, the present invention will be described in more detail with reference to Examples, but the present invention is not limited to these Examples, and the present invention can take various aspects as long as the problems of the present invention can be solved.

### EXAMPLES

### [1. Evaluation Test Based on Variation of Dextrin Content and Brix Value in the Liquid Seasoning]

### 1-1. Liquid Seasoning Preparation

To each of 10% sugar aqueous solution, 25% sugar aqueous solution, and 40% sugar aqueous solution, 1.0 g, 4.0 g, 9.0 g, 14.0 g, 19.0 g, and 29.0 g of dextrin (“Pinedex #1 (DE value 8)”, manufactured by Matsutani Chemical Industry Co., Ltd.) were added, respectively, and stirred to prepare liquid seasonings 1-1 to 3-6 (100 g each). Tables 1 to 3 below show the content of each ingredient and the Brix value of each liquid seasoning.

### 1-2. Heat Treatment

100 g of each of the liquid seasonings 1-1 to 3-6 and 50 g of mochi (“Half-cut mochi for business use”, manufactured by Iris Foods) were filled into a retort container (“Plain bag for retort”, manufactured by Shueido), and the opening of the retort container was sealed using a vacuum sealer. A shower-type retort sterilizer was used to retort sterilize to produce heat-treated mochi-containing foods 1-1 to 3-6. Retort sterilization treatment conditions were 125° C. setting, maximum pressure of 0.25 MPa, heating for 9 minutes after the temperature in the apparatus reached 125° C., and F value of 7.7.

### 1-3. Measurement of Brix Value

The Brix value of each of the liquid seasonings 1-1 to 3-6 was measured after preparing the liquid seasonings (before filling the retort container) according to the following measurement conditions. The results are shown in Tables 1 to 3.

The Brix value of each of the heat-treated mochi-containing foods 1-1 to 3-6 was measured under the following conditions. For the measurement, the heat-treated mochi-containing food was stored at room temperature (15° C. to 25° C.) for 14 days, then placed in boiling water for 10 minutes, the retort container was opened, the mochi and liquid seasoning were took out, and they were mixed and pasted using a food processor (“DLC-NXJ2SS”, manufactured by Cuisinart) for 2 minutes to obtain a paste-like sample. Then the opening of the retort container with sample was sealed again, followed by placing in boiling water for 15 minutes, the retort container was opened again, and the sample was allowed to stand until the sample temperature reached 20° C. before measurement. The results are shown in Tables 1 to 3.

### [Measurement Conditions]

A hand-held refractometer (“MASTER-AH50”, manufactured by AS ONE) was used as a Brix meter to measure the Brix values at the temperature of sample of 20° C. The measurement was performed 10 times, and the average value was calculated.

### 1-4. Measurement of Strength (Elastic Load)

The heat-treated mochi-containing foods 1-1 to 3-6 were stored at room temperature (15° C. to 25° C.) for 14 days, then placed in boiling water for 10 minutes, and the strength of mochi immediately after opening the retort container was measured under the following measurement conditions. The results are shown in Tables 1 to 3.

In addition, 50 g of mochi similar to those used in the production of heat-treated mochi-containing foods 1-1 to 3-6 was placed into 100 g of boiling water and boil heat-treated for 2 minutes (hereinafter also referred to as “normally-heated mochi A”), of which the strength was 0.788 N. In the present invention, if strength is obtained as much as that of aforementioned normally-heated mochi±0.3 N, it is considered to have sufficient strength, i.e., the firmness (texture) of mochi is maintained.

### [Measurement Conditions]

Using a measuring device (“Rheometer CD-500X”, manufactured by SUN SCIENTIFIC CO., LTD. (plunger used: No. 10 for shearing (wedge type)), the breaking strength (unit: N (Newton)) of mochi was measured when pushing in to 8 mm. The measurement was performed 5 times, and the average value was calculated.

### 1-5. Sensory Evaluation

The appearance (shape) and texture of mochi were evaluated by five panelists with discriminating ability on heat-treated mochi-containing foods 1-1 to 3-6 according to the following evaluation criteria. The average scores of the five panel members are shown in Tables 1 to 3.

### [Evaluation Criteria]

### Appearance of Mochi

1: Melted
2: Slightly melted
3: Well-organized

### Texture of Mochi

1: Soft or firm
2: Slightly soft or slightly firm
3: Good enough

The appearance and the texture of mochi are considered acceptable if the average score is 2 or higher.

TABLE 1

| | Mochi- | Mochi- | Mochi- | Mochi- | Mochi- | Mochi- |
|---|---|---|---|---|---|---|
| | containing | containing | containing | containing | containing | containing |
| | food 1-1 | food 1-2 | food 1-3 | food 1-4 | food 1-5 | food 1-6 |
| | Liquid | Liquid | Liquid | Liquid | Liquid | Liquid |
| | seasoning | seasoning | seasoning | seasoning | seasoning | seasoning |
| 10% Sugar aqueous solution | 1-1 | 1-2 | 1-3 | 1-4 | 1-5 | 1-6 |
| Amount of dextrin (g) | 1.0 | 4.0 | 9.0 | 14.0 | 19.0 | 29.0 |
| (in 100 g of liquid seasoning) | | | | | | |
| Amount of sugar (g) | 9.9 | 9.6 | 9.1 | 8.6 | 8.0 | 7.1 |
| (in 100 g of liquid seasoning) | | | | | | |
| Brix value of liquid seasoning | 11.0 | 13.5 | 18.0 | 22.0 | 27.0 | 37.0 |
| Brix value of mochi-containing food | 27.0 | 29.0 | 31.5 | 34.5 | 37.0 | 44.0 |
| Strength (N) | 0.211 | 0.292 | 0.377 | 0.401 | 0.501 | 0.921 |
| Appearance of mochi | 1.4 | 1.6 | 2.2. | 2.6 | 2.8 | 3.0 |
| Texture of mochi | 1.0 | 1.0 | 1.0 | 1.4 | 2.2 | 1.8 |

TABLE 2

| | Mochi- | Mochi- | Mochi- | Mochi- | Mochi- | Mochi- |
|---|---|---|---|---|---|---|
| | containing | containing | containing | containing | containing | containing |
| | food | food | food | food | food | food |
| | 2-1 | 2-2 | 2-3 | 2-4 | 2-5 | 2-6 |
| | Liquid | Liquid | Liquid | Liquid | Liquid | Liquid |
| | seasoning | seasoning | seasoning | seasoning | seasoning | seasoning |
| 25% Sugar aqueous solution | 2-1 | 2-2 | 2-3 | 2-4 | 2-5 | 2-6 |
| Amount of dextrin (g) | 1.0 | 4.0 | 9.0 | 14.0 | 19.0 | 29.0 |
| (in 100 g of liquid seasoning) | | | | | | |
| Amount of sugar (g) | 24.8 | 24.0 | 22.8 | 21.5 | 20.3 | 17.8 |
| (in 100 g of liquid seasoning) | | | | | | |
| Brix value of liquid seasoning | 26.0 | 28.0 | 32.0 | 36.5 | 39.0 | 47.5 |
| Brix value of mochi-containing food | 36.5 | 38.0 | 40.5 | 43.0 | 45.0 | 51.0 |
| Strength (N) | 0.495 | 0.687 | 0.738 | 0.850 | 0.964 | 1.360 |
| Appearance of mochi | 2.8 | 3.0 | 3.0 | 3.0 | 3.0 | 3.0 |
| Texture of mochi | 2.4 | 2.6 | 2.6 | 2.8 | 3.0 | 1.6 |

TABLE 3

| | Mochi- | Mochi- | Mochi- | Mochi- | Mochi- | Mochi- |
|---|---|---|---|---|---|---|
| | containing | containing | containing | containing | containing | containing |
| | food | food | food | food | food | food |
| | 3-1 | 3-2 | 3-3 | 3-4 | 3-5 | 3-6 |
| | Liquid | Liquid | Liquid | Liquid | Liquid | Liquid |
| | seasoning | seasoning | seasoning | seasoning | seasoning | seasoning |
| 40% Sugar aqueous solution | 3-1 | 3-2 | 3-3 | 3-4 | 3-5 | 3-6 |
| Amount of dextrin (g) | 1.0 | 4.0 | 9.0 | 14.0 | 19.0 | 29.0 |
| (in 100 g of liquid seasoning) | | | | | | |
| Amount of sugar | 39.6 | 38.4 | 36.4 | 34.4 | 32.4 | 28.4 |
| (in 100 g of liquid seasoning) | | | | | | |
| Brix value of liquid seasoning | 40.5 | 42.5 | 45.5 | 49.0 | 52.5 | 58.0 |
| Brix value of mochi-containing food | 46.5 | 47.5 | 50.0 | 52.0 | 54.0 | 58.0 |
| Strength (N) | 0.962 | 0.995 | 0.998 | 1.040 | 1.081 | 1.450 |
| Appearance of mochi | 3.0 | 3.0 | 3.0 | 3.0 | 3.0 | 3.0 |
| Texture of mochi | 3.0 | 3.0 | 3.0 | 2.6 | 2.2 | 1.8 |

From the results in Tables 1 to 3, it was confirmed that each of mochi contained in the heat-treated mochi-containing foods 1-5, 2-1, 2-2, 2-3, 2-4, 2-5, 3-1, 3-2, 3-3, 3-4, and 3-4 which used liquid seasonings containing dextrin in a ratio between 1.0% by mass or more and less than 20.0% by mass and a Brix value of 26.0% to 49.0%, was equivalent to the normally-heated mochi A in the strength, and obtained highly evaluation results in both of the texture and appearance. On the other hand, for the heat-treated mochi-containing foods 1-1 to 1-4 which used liquid seasonings containing dextrin at a ratio between 1.0% by mass or more and less than 20.0% by mass, but having Brix values not within the range of 26.0% to 52.5%, it was confirmed that the strength of mochi was lower than that of normally-heated mochi A, and neither the texture nor the appearance of their mochi could obtain favorable evaluation results. As for the heat-treated mochi-containing foods 1-6 and 2-6, since liquid seasonings has Brix values within the range of 26.0% to 52.5% but dextrin at a ratio between 20.0% by mass or more, the strength of mochi was equivalent to that of normally-heated mochi A, however, the viscosity of the liquid seasoning was higher, resulting in less covering and surrounding mochi. In addition, for the heat-treated mochi-containing food 3-6 using liquid seasoning containing dextrin at a ratio between 20.0% by mass or more and having a Brix value not within the range of 26.0% to 52.5%, the strength of mochi was higher than that of normally-heated mochi A, and the viscosity of the liquid seasoning was also higher, resulting in less covering and surrounding mochi.

### [2. Evaluation Test of Heat-Treated Mochi-Containing Food (Shiruko)]

### 2-1. Production of Heat-Treated Mochi-Containing Food (Shiruko)

7.0 g of dextrin (“Pinedex #1 (DE value 8)”, manufactured by Matsutani Chemical Industry Co., Ltd.), 40.0 g of coarse sweet red bean paste, and 53.0 g of water were blended and stirred to prepare liquid seasoning 4. One hundred grams of this liquid seasoning was filled with 35 g of mochi (“Frozen Tokusen Shiratama”, manufactured by Tanuma Corporation) into a retort container (“Plain bag for retort”, manufactured by Shueido), and the opening of the retort container was sealed using a vacuum sealing machine. A shower-type retort sterilizer was used for heat sterilization treatment to produce mochi-containing food 4. The conditions for the pressure heat sterilization treatment were 125° C. setting, maximum pressure of 0.25 MPa, heating for 6 minutes after the temperature in the apparatus reached 125° C., and an F value of 6.9.

### 2-2. Measurement of Brix Value

In heat-treated mochi-containing food 4, the Brix values of the liquid seasoning and the heat-treated mochi-containing food were measured in the same manner as described in 1-3 above. The results are shown in Table 4.

### 2-3. Measurement of Strength (Elastic Load)

The breaking strength of mochi in heat-treated mochi-containing food 4 was measured using the same method as described in 1-4 above. The results are shown in Table 4.

In addition, the 35 g of mochi which is similar to the mochi used in the production of heat-treated mochi-containing food 4 was placed into 100 g of boiling water and boil heat-treated for 1 minute (hereinafter also referred to as “normally-heated mochi B”), of which the strength was 0.506 N.

### 2-4. Sensory Evaluation

Sensory evaluation of heat-treated mochi-containing food 4 was conducted in the same manner as described in 1-5 above. The results are shown in Table 4.

TABLE 4

| Mochi-containing food 4 | | Content (g) |
|---|---|---|
| Mochi | Shiratama | 35.0 |
| Liquid | Dextrin | 7.0 |
| seasoning | Coarse sweet red bean paste | 40.0 |
| | Water | 53.0 |

| | |
|---|---|
| Brix value of liquid seasoning | 29.5 |
| Brix value of mochi-containing food | 39.0 |
| Strength (N) | 0.553 |
| Appearance of mochi | 3.0 |
| Texture of mochi | 3.0 |

The results in Table 4 show that, for heat-treated mochi-containing food 4, when using a liquid seasoning containing dextrin at a ratio between 1.0% by mass or more and less than 20.0% by mass and having a Brix value of 26.0% to 52.5%, the strength of mochi is equivalent to that of the normally-heated mochi B, and the texture and appearance of mochi is maintained, regardless of the type of liquid seasoning and the type of mochi.

### [3. Evaluation Test of Heat-Treated Mochi-Containing Food (Tteokbokki)]

### 3-1. Production of Heat-Treated Mochi-Containing Food (Tteokbokki)

Dextrin (“Padded index #1 (DE value 8)”, manufactured by Matsutani Chemical Industry Co., Ltd.) 7.0 g, sauce for tteokbokki (“Instant Tteokbokki”, manufactured by CJ; with gochujang, starch syrup, sugar, etc.) 39.0 g, gluconic acid 0.6 g, water 13.4 g were mixed and stirred to prepare liquid seasoning 5. Sixty grams of this liquid seasoning were filled with 100 g of mochi (“tteokbokki”, manufactured by Johoku Menko) into a retort container (“plain bag for retort”, manufactured by Shueido), and the opening of the retort container was sealed using a vacuum sealer. A shower-type retort sterilizer was used for heat sterilization treatment to produce mochi-containing food 5. The conditions for the pressure heat sterilization treatment were 100° C. setting, maximum pressure of 0.25 MPa, and heating for 20 minutes after the temperature in the apparatus reached 100° C.

### 3-2. Measurement of pH Value

Heat-treated mochi-containing food 5 was stored at room temperature (15° C. to 25° C.) for 14 days, then placed in boiling water for 10 minutes and the pH value of the liquid seasoning immediately after opening the retort container was measured by a pH meter (“Lakom tester pH meter”, manufactured by As One). The results are shown in Table 5.

### 3-3. Measurement of Brix Value

In heat-treated mochi-containing food 5, the Brix values of the liquid seasoning and the heat-treated mochi-containing food were measured in the same manner as described in 1-3 above. The results were shown in Table 5.

### 3-4. Measurement of Strength (Elastic Load)

The breaking strength of mochi in heat-treated mochi-containing food 5 was measured using the same manner as described in 1-4 above. The results are shown in Table 5.

In addition, 100 g of mochi which is similar to the mochi used in heat-treated mochi-containing food 5 produced above was placed in 100 g of boiling water and boil heat-treated for 2 minutes (hereinafter also referred to as “normally-heated mochi C”), of which breaking strength was 1.260 N.

### 3-5. Sensory Evaluation

Sensory evaluation of heat-treated mochi-containing food 5 was conducted in the same manner as described in 1-5 above. The results are shown in Table 5.

TABLE 5

| Mochi-containing food 5 | | Content (g) |
|---|---|---|
| Mochi | Tteokbokki | 100.0 |
| Liquid | Dextrin | 7.0 |
| seasoning | Sauce for tteokbokki | 39.0 |
| | Gluconic acid | 0.6 |
| | Water | 13.4 |

| | |
|---|---|
| pH value | 4.2 |
| Brix value of liquid seasoning | 48.5 |
| Brix value of mochi-containing food | 54.0 |
| Strength (N) | 1.050 |
| Appearance of mochi | 3.0 |
| Texture of mochi | 3.0 |

From the results in Table 5, it was confirmed that heat-treated mochi-containing food 5, when using a liquid seasoning containing dextrin at a ratio between 1.0% by mass or more and less than 20.0% by mass and having a Brix value of 26.0% to 52.5%, the strength of mochi was equivalent to that of normally-heated mochi C, and the texture and appearance of mochi is maintained, regardless of the types of liquid seasoning, mochi, or heat treatment method.

### INDUSTRIAL APPLICABILITY

The heat-treated mochi-containing food according to one embodiment of the present invention maintains the texture and appearance of mochi without impairing its original taste, thus providing additional value as a new processed food product.

1. A heat-treated mochi-containing food comprising a liquid seasoning and mochi, wherein the liquid seasoning comprises dextrin at a ratio between 1.0% by mass or more and less than 20.0% by mass and has a Brix value of 26.0% to 52.5%.

2. The heat-treated mochi-containing food according to claim 1, wherein the heat-treated mochi-containing food has a Brix value of 36.5% to 54.0%.

3. The heat-treated mochi-containing food according to claim 1, wherein the liquid seasoning is comprised at a ratio of 50 parts by mass to 300 parts by mass relative to 100 parts by mass of the mochi.

4. The heat-treated mochi-containing food according to claim 1, wherein the heat-treated mochi-containing food is packed in a retort container.

5. A method of producing a heat-treated mochi-containing food, comprising subjecting mochi to heat treatment in a liquid seasoning that comprises dextrin at a ratio between 1.0% by mass or more and less than 20.0% by mass and has a Brix value of 26.0% to 52.5%, to obtain the heat-treated mochi-containing food.

6. The method according to claim 5, wherein the heat-treated mochi-containing food has a Brix value of 36.5% to 54.0%.

7. The method according to claim 5, wherein the liquid seasoning is comprised at a ratio of 50 parts by mass to 300 parts by mass relative to 100 parts by mass of the mochi.

8. The method according to claim 5, wherein the heat treatment is a retort sterilization treatment.

9. A liquid seasoning for heat-treating mochi, comprising dextrin at a ratio between 1.0% by mass or more and less than 20.0% by mass and having a Brix value of 26.0% to 52.5%.

10. A method for preventing collapse of the shape of mochi during heating, comprising subjecting mochi to heat treatment in a liquid seasoning that comprises dextrin at a ratio between 1.0% by mass or more and less than 20.0% by mass and has a Brix value of 26.0% to 52.5%.

11. The heat-treated mochi-containing food according to claim 2, wherein the liquid seasoning is comprised at a ratio of 50 parts by mass to 300 parts by mass relative to 100 parts by mass of the mochi.

12. The heat-treated mochi-containing food according to claim 2, wherein the heat-treated mochi-containing food is packed in a retort container.

13. The heat-treated mochi-containing food according to claim 3, wherein the heat-treated mochi-containing food is packed in a retort container.

14. The heat-treated mochi-containing food according to claim 11, wherein the heat-treated mochi-containing food is packed in a retort container.

15. The method according to claim 6, wherein the liquid seasoning is comprised at a ratio of 50 parts by mass to 300 parts by mass relative to 100 parts by mass of the mochi.

16. The method according to claim 6, wherein the heat treatment is a retort sterilization treatment.

17. The method according to claim 7, wherein the heat treatment is a retort sterilization treatment.

18. The method according to claim 15, wherein the heat treatment is a retort sterilization treatment.
